(19) United States
(12) Patent Application Publication
(10) Pub. No.: US 2024/0071702 A1
(43) Pub. Date: Feb. 29, 2024

(54) ELECTROMAGNETIC RELAY

(71) Applicant: OMRON Corporation, Kyoto-shi (JP)

(72) Inventors: Kohei OTSUKA, Kyoto-shi (JP); Ayata HORIE, Kyoto-shi (JP); Hiroyuki IWASAKA, Kyoto-shi (JP); Ryota MINOWA, Kyoto-shi (JP); Shinichi OGAWA, Kyoto-shi (JP)

(21) Appl. No.: 18/360,812

(22) Filed: Jul. 28, 2023

(30) Foreign Application Priority Data
Aug. 25, 2022 (JP) 2022-134448

(51) Int. Cl. H01H 50/54; H01H 50/02

(52) U.S. Cl. CPC H01H 50/546; H01H 50/02

(57) ABSTRACT

An electromagnetic relay includes a fixed contact, a movable contact, a movable contact piece, a case, and an adhesive material. The movable contact is disposed to face the fixed contact. The movable contact piece is connected to the movable contact. The movable contact piece is movable between a closed position in which the movable contact is in contact with the fixed contact and an open position in which the movable contact is separated from the fixed contact. The case accommodates the fixed contact and the movable contact. The adhesive material is disposed in the case. The adhesive material captures foreign matter in the case.

### CROSS-REFERENCE TO RELATED APPLICATION

This application claims priority to Japanese Patent Application No. 2022-134448, filed Aug. 25, 2022. The contents of that application are incorporated by reference herein in their entirety.

### FIELD

The present invention relates to an electromagnetic relay.

### BACKGROUND

An electromagnetic relay includes a fixed contact, a movable contact, a movable contact piece, and a case. The movable contact faces the fixed contact and is connected to the movable contact piece. The movable contact piece is movable between a closed position and an open position. When the movable contact piece is located at the closed position, the movable contact contacts the fixed contact. When the movable contact piece is at the open position, the movable contact is separated from the fixed contact. The fixed contact and the movable contact are disposed in the case (see, for example, JP-A-2017-079109).

### SUMMARY

In an electromagnetic relay, a movable member such as a movable contact piece slides against another member such as a case. As a result, foreign matter such as abrasion powder may be generated inside the case. Alternatively, if there is a gap in the case, foreign matter may enter the case from the outside of the electromagnetic relay through the gap. If foreign matter adheres to the movable contact or the fixed contact, the stability of the contact between the movable contact and the fixed contact decreases. An object of the present invention is to reduce adhesion of foreign matter to a contact in an electromagnetic relay.

An electromagnetic relay according to one aspect of the present invention includes a fixed contact, a movable contact, a movable contact piece, a case, and an adhesive material. The movable contact is disposed to face the fixed contact. The movable contact piece is connected to the movable contact. The movable contact piece is movable between a closed position in which the movable contact is in contact with the fixed contact and an open position in which the movable contact is separated from the fixed contact. The case accommodates the fixed contact and the movable contact. The adhesive material is disposed in the case. The adhesive material captures foreign matter in the case.

In the electromagnetic relay according to the present aspect, when foreign matter is generated in the case or when foreign matter enters the case, the foreign matter is captured by the adhesive material. As a result, adhesion of foreign matter to the fixed contact or the movable contact is reduced.

The electromagnetic relay may further include a movable member disposed in the case. The adhesive material may be disposed between the movable member and the fixed contact or the movable contact. In this case, even if foreign matter such as abrasion powder is generated in the case by a motion of the movable member, the foreign matter is captured by the adhesive material before reaching the fixed contact or the movable contact.

The cases may include a first case and a second case. The second case may be provided separately from the first case. The second case may be attached to the first case. The adhesive material may be disposed between a gap between the first case and the second case and the fixed contact or the movable contact. In this case, even if foreign matter enters the case through the gap of the case, the foreign matter is captured by the adhesive material before reaching the fixed contact or the movable contact.

The adhesive material may have an uneven surface. In this case, the unevenness increases the surface area of the adhesive material. As a result, foreign matter is effectively trapped by the adhesive.

An inner surface of the case may have unevenness. The adhesive material may be attached onto the unevenness. In this case, the unevenness of the case forms unevenness on the surface of the adhesive material. As a result, the surface area of the adhesive material is increased, and the foreign matter is effectively captured by the adhesive material.

The inner surface of the case may include a corner. The adhesive material may be attached to the corner. In this case, foreign matter that collects at the corner of the case is effectively captured by the adhesive material.

The electromagnetic relay may further include a magnet and a wall portion. The magnet may generate a magnetic force to induce an arc generated between the movable contact and the fixed contact. The wall portion may be disposed to face the adhesive material in the case. The wall portion may protect the adhesive material from the arc. In this case, deterioration of the adhesive material due to the arc is suppressed by the wall portion.

### BRIEF DESCRIPTION OF THE DRAWINGS

FIG. 1 is a cross-sectional view of an electromagnetic relay in an open state according to a first embodiment.

FIG. 2 is a cross-sectional view of the electromagnetic relay in a closed state.

FIG. 3 is an enlarged view of a case and a contact device.

FIG. 4 is a diagram showing an electromagnetic relay according to a second embodiment.

FIG. 5 is a diagram showing an adhesive material according to a first modified example.

FIG. 6 is a diagram showing an adhesive material according to a second modified example.

FIG. 7 is a diagram showing a contact device and a case according to a third modified example.

FIG. 8 is a diagram showing a contact device and a case according to a fourth modified example.

FIG. 9 is a cross-sectional view taken along line IX-IX in FIG. 8.

### DETAILED DESCRIPTION

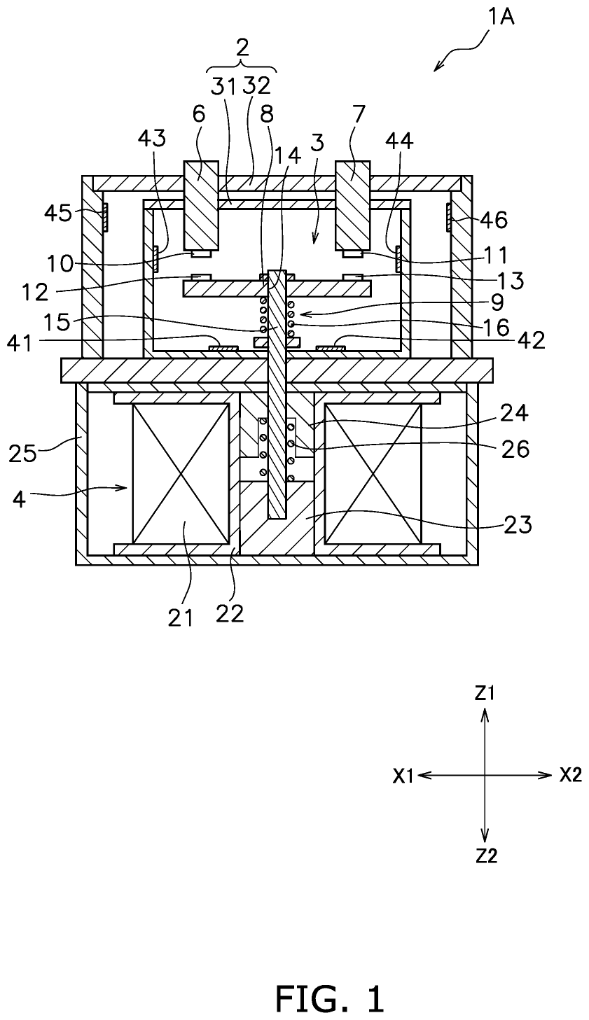

An electromagnetic relay according to an embodiment of the present invention will be described below with reference to the drawings. FIG. 1 is a cross-sectional view of an electromagnetic relay 1A according to a first embodiment. As shown in FIG. 1, the electromagnetic relay 1A includes a case 2, a contact device 3, and a drive device 4. The case 2 is made of an insulating material such as resin or ceramic. The contact device 3 is accommodated in the case 2. The contact device 3 includes a first fixed terminal 6, a second fixed terminal 7, a movable contact piece 8, a movable mechanism 9, a first fixed contact 10, a second fixed contact 11, a first movable contact 12, and a second movable contact 13.

In the following description, a direction in which the first fixed contact 10 and the first movable contact 12 face each other are defined as a moving direction (Z1, Z2). The moving direction (Z1, Z2) include a contact direction (Z1) and a separation direction (Z2). A direction in which the movable contacts 12 and 13 approach the fixed contacts 10 and 11 is defined as the contact direction (Z1). A direction in which the movable contacts 12 and 13 separate from the fixed contacts 10 and 11 is defined as the separation direction (Z2).

A direction in which the movable contact piece 8 extends is defined as a longitudinal direction (X1, X2). The longitudinal direction (X1, X2) is the direction perpendicular to the moving direction (Z1, Z2). The longitudinal direction (X1, X2) includes a first longitudinal direction (X1) and a second longitudinal direction (X2). The second longitudinal direction (X2) is opposite to the first longitudinal direction (X1). A direction from the second fixed contact 11 to the first fixed contact 10 is defined as the first longitudinal direction (X1). A direction from the first fixed contact 10 to the second fixed contact 11 is defined as the second longitudinal direction (X2).

The first fixed terminal 6, the second fixed terminal 7, the movable contact piece 8, the first fixed contact 10, the second fixed contact 11, the first movable contact 12, and the second movable contact 13 are each made of electrically conductive material. For example, the first fixed terminal 6, the second fixed terminal 7, and the movable contact piece 8 are made of a metal known as a terminal material such as a copper-based metal. However, the first fixed terminal 6, the second fixed terminal 7, and the movable contact piece 8 may be made of materials different from these materials. The first fixed contact 10, the second fixed contact 11, the first movable contact 12, and the second movable contact 13 are made of metal known as a contact material such as copper-based metal or silver-based metal.

The first fixed terminal 6 and the second fixed terminal 7 are disposed apart from each other in the longitudinal direction (X1, X2). The first fixed terminal 6 and the second fixed terminal 7 protrude from inside the case 2 to the outside of the case 2. The first fixed contact 10 is connected to the first fixed terminal 6. The second fixed contact 11 is connected to the second fixed terminal 7. The first fixed contact 10 and the second fixed contact 11 are disposed in the case 2.

The movable contact piece 8, the first movable contact 12, and the second movable contact 13 are disposed in the case 2. The first movable contact 12 and the second movable contact 13 are connected to the movable contact piece 8. The first movable contact 12 faces the first fixed contact 10. The second movable contact 13 faces the second fixed contact 11. The first movable contact 12 is disposed apart from the second movable contact 13 in the longitudinal direction (X1, X2).

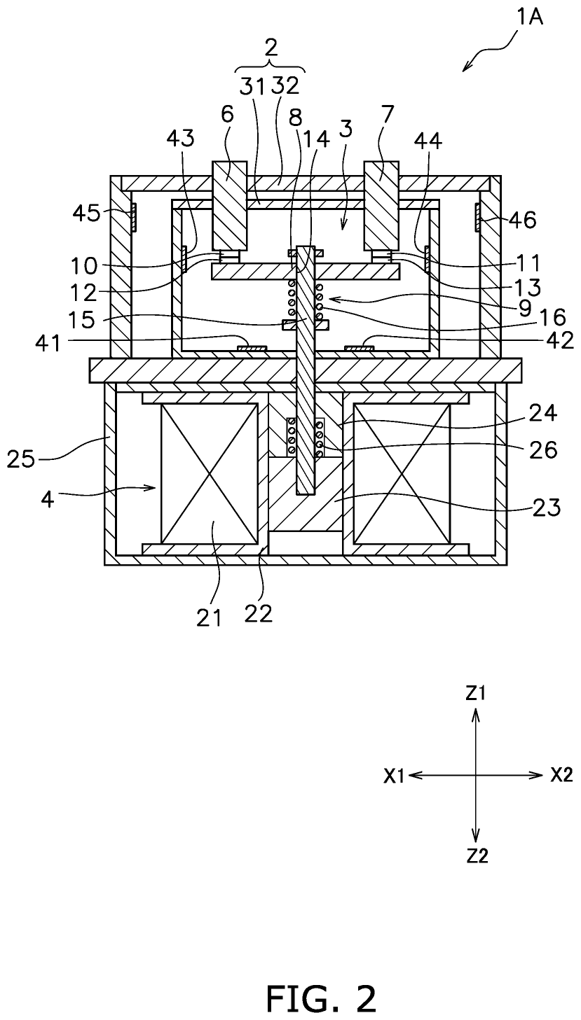

The movable contact piece 8 is movable in the moving direction (Z1, Z2). The movable contact piece 8 is movable between an open position shown in FIG. 1 and a closed position shown in FIG. 2. As shown in FIG. 1, when the movable contact piece 8 is at the open position, the movable contacts 12 and 13 are separated from the fixed contacts 10 and 11. As shown in FIG. 2, when the movable contact piece 8 is at the closed position, the movable contacts 12 and 13 are in contact with the fixed contacts 10 and 11.

The movable mechanism 9 supports the movable contact piece 8. The movable mechanism 9 includes a drive shaft 15 and a contact spring 16. The drive shaft 15 is connected to the movable contact piece 8. The drive shaft 15 extends in the moving direction (Z1, Z2) through the hole 14 of the movable contact piece 8. The drive shaft 15 is movable relative to the movable contact piece 8. The drive shaft 15 is configured to move in the moving direction (Z1, Z2). The contact spring 16 biases the movable contact piece 8 in the contact direction (Z1).

As shown in FIGS. 1 and 2, the drive device 4 moves the drive shaft 15 in the moving direction (Z1, Z2). The drive device 4 includes a coil 21, a spool 22, a movable iron core 23, a fixed iron core 24, a yoke 25, and a return spring 26. The drive device 4 uses electromagnetic force to move the movable contact piece 8 between the open position and the closed position via the movable mechanism 9. The coil 21 is wound around the spool 22. The movable iron core 23 and the fixed iron core 24 are disposed in the spool 22. The movable iron core 23 is connected to the drive shaft 15. The movable iron core 23 is movable in the moving direction (Z1, Z2). The fixed iron core 24 is disposed to face the movable iron core 23. The return spring 26 biases the movable iron core 23 in the separation direction (Z2).

In the electromagnetic relay 1A, when the coil 21 is energized, the magnetic force of the coil 21 attracts the movable iron core 23 to the fixed iron core 24. Thereby, the movable iron core 23 and the drive shaft 15 move in the contact direction (Z1) against the biasing force of the return spring 26. Thereby, the movable contact piece 8 moves to the closed position shown in FIG. 2 and the movable contacts 12 and 13 contact the fixed contact.

After the movable contacts 12 and 13 first come into contact with the fixed contacts 10 and 11, the contact spring 16 is compressed by further movement of the drive shaft 15 in the contact direction (Z1). A contact follow is defined as a distance that the drive shaft 15 moves further in the contact direction (Z1) from the position at which the movable contacts 12 and 13 first come into contact with the fixed contacts 10 and 11.

When the coil 21 is de-energized, the movable iron core 23 and the drive shaft 15 are moved in the separation direction (Z2) by the biasing force of the return spring 26. As a result, the movable contact piece 8 moves to the open position shown in FIG. 1 and the movable contacts 12 and 13 are separated from the fixed contacts 10 and 11.

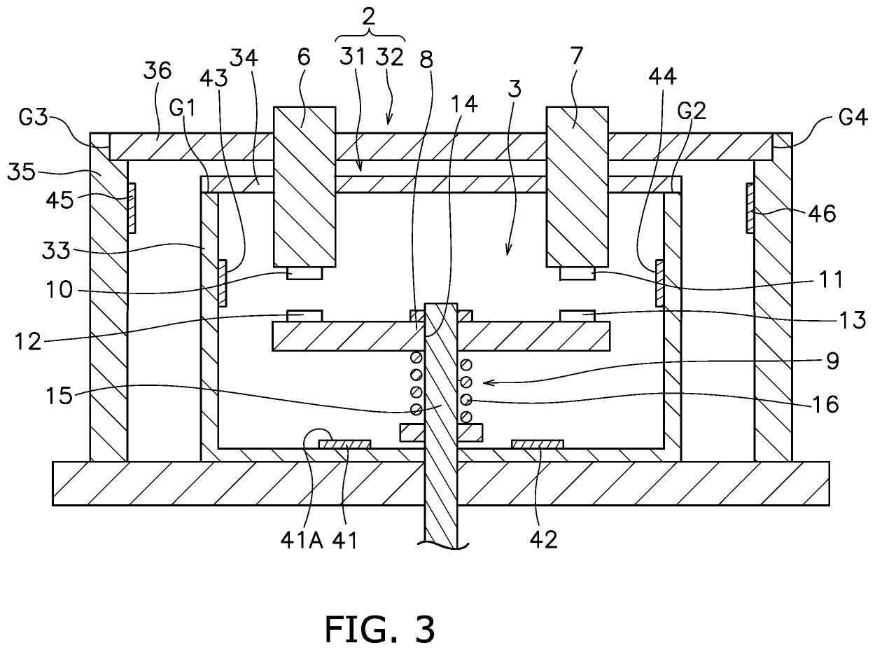

FIG. 3 is an enlarged view of the case 2 and the contact device 3. As shown in FIG. 3, the case 2 includes an inner case 31 and an outer case 32. The inner case 31 is disposed within the outer case 32. The contact device 3 is disposed within the inner case 31. The inner case 31 includes a first inner case 33 and a second inner case 34. The first inner case 33 and the second inner case 34 are provided separately from each other. The second inner case 34 is attached to the first inner case 33.

The outer case 32 includes a first outer case 35 and a second outer case 36. The first outer case 35 and the second outer case 36 are provided separately from each other. The second outer case 36 is attached to the first outer case 35.

The electromagnetic relay 1A includes adhesive materials (i.e., portions of material that are adhesive) 41 to 46. The adhesive materials 41 to 46 are disposed in the case 2. The adhesive material 41 includes an adhesive surface 41A having adhesiveness (i.e., tackiness or stickiness). The adhesive material 41 is disposed so that the adhesive surface 41A is exposed to a space in the case 2. The other adhesive materials 42 to 46 also include adhesive (i.e., tacky or sticky) surfaces similar to the adhesive material 41, and are disposed with the adhesive surfaces exposed to the space in the case 2. The adhesive materials 41 to 46 include, for example, acrylic adhesives, silicone adhesives, urethane adhesives, or rubber adhesives that are tacky or sticky. The adhesive materials 41 to 46 may be adhesive tapes. The adhesive materials 41 to 46 capture foreign matter in case 2.

The adhesive materials 41 to 44 are disposed in the inner case 31. The adhesive materials 41 and 42 are attached to a bottom surface of the inner case 31. The adhesive materials 41 and 42 are disposed facing a position where the drive shaft 15 and the inner case 31 contact each other. The adhesive material 41 is disposed in a path between the position where the drive shaft 15 and the inner case 31 contact and the first fixed contact 10 or the first movable contact 12. The adhesive material 42 is disposed in a path between the position where the drive shaft 15 and the inner case 31 contact and the second fixed contact 11 or the second movable contact 13.

The adhesive materials 43 and 44 are attached to the side surfaces of the inner case 31. The adhesive material 43 is disposed between a gap G1 between the first inner case 33 and the second inner case 34 and the first fixed contact 10 or the first movable contact 12. The adhesive material 43 is disposed facing the first fixed contact 10 or the first movable contact 12. The adhesive material 44 is disposed between a gap G2 between the first inner case 33 and the second inner case 34 and the second fixed contact 11 or the second movable contact 13. The adhesive material 44 is disposed facing the second fixed contact 11 or the second movable contact 13.

The adhesive materials 45 and 46 are attached to the side surfaces of the outer case 32. The adhesive material 45 is disposed between a gap G3 between the first outer case 35 and the second outer case 36 and the first fixed contact 10 or the first movable contact 12. The adhesive material 45 is disposed facing the gap G3 between the first outer case 35 and the second outer case 36. The adhesive material 46 is disposed between a gap G4 between the first outer case 35 and the second outer case 36 and the second fixed contact 11 or the second movable contact 13. The adhesive material 46 is disposed facing the gap G4 between the first outer case 35 and the second outer case 36.

In the electromagnetic relay 1A according to the present embodiment described above, when foreign matter is generated in the case 2 or enters the case 2, the foreign matter is captured by the adhesive materials 41 to 46. As a result, adhesion of foreign matter to fixed contacts 10 and 11 or movable contacts 12 and 13 is reduced.

Although one embodiment of the present invention has been described above, the present invention is not limited to the above-described embodiment, and various modifications are possible without departing from the scope of the invention. Various modifications may be useable with each so long as they are not contradictory or inconsistent with each other.

The structure of the drive device 4 is not limited to that of the above embodiment, and may be modified. For example, in the above embodiment, the drive device 4 is disposed in the separation direction (Z2) of the contact device 3. However, the drive device 4 may be disposed with respect to the contact device 3 in the longitudinal direction (X1, X2) or in the lateral direction perpendicular to the moving direction (Z1, Z2) and the longitudinal direction (X1, X2). The separation direction (Z2) and the contact direction (Z1) may be opposite to those in the above embodiment.

The structure of the contact device 3 is not limited to that of the above embodiment, and may be modified. For example, the first fixed contact 10 may be provided separately from or integral with the first fixed terminal 6. The second fixed contact 11 may be provided separately from or integrated with the second fixed terminal 7. The first movable contact 12 may be provided separately from or integral with the movable contact piece 8. The second movable contact 13 may be provided separately from or integral with the movable contact piece 8. The number of fixed contacts is not limited to two, and may be one or more than two. The number of movable contacts is not limited to two, and may be one or more than two.

The electromagnetic relay 1A according to the above embodiment is a so-called plunger type electromagnetic relay. However, the electromagnetic relay is not limited to the plunger type, and may be of other types such as a hinge type.

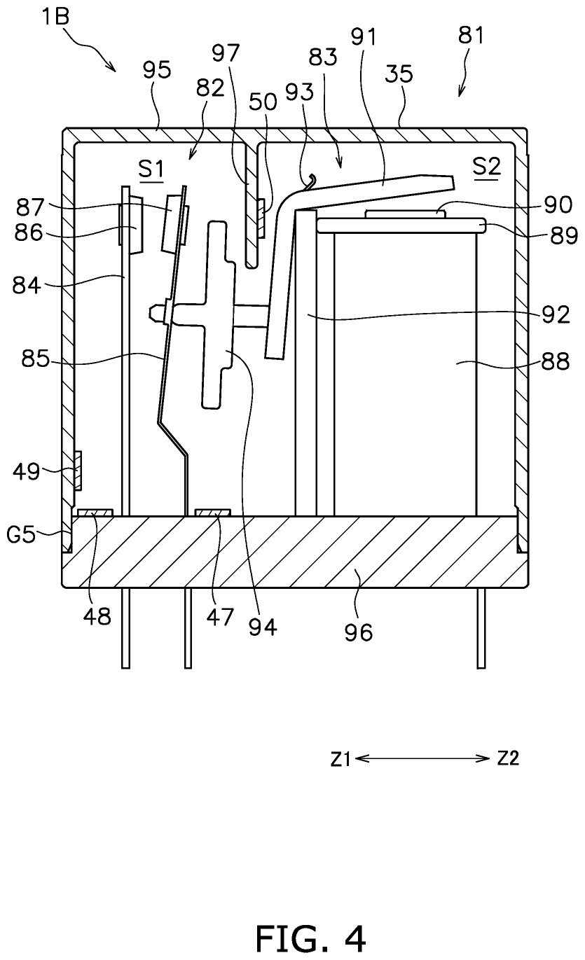

For example, FIG. 4 is a diagram showing an electromagnetic relay 1B according to a second embodiment. The electromagnetic relay 1B is a hinge-type electromagnetic relay. As shown in FIG. 4, the electromagnetic relay 1B includes a case 81, a contact device 82, and a drive device 83. The contact device 82 and the drive device 83 are disposed in the case 81. The contact device 82 includes a fixed terminal 84, a movable contact piece 85, a fixed contact 86, and a movable contact 87. The drive device 83 includes a coil 88, a spool 89, an iron core 90, an armature 91, a yoke 92, a return spring 93, and a card 94.

The case 81 includes a first case 95 and a second case 96. The first case 95 and the second case 96 are provided separately from each other. The second case 96 is attached to the first case 95. The contact device 82 and the drive device 83 are disposed on the second case 96. The first case 95 covers the contact device 82, the drive device 83, and the second case 96 from above. The first case 95 includes a partition wall 97. The partition wall 97 protrudes downward from a top surface of the first case 95. The partition wall 97 is disposed in the case 81 between a first space S1 and a second space S2. The contact device 82 is disposed in the first space S1. The drive device 83 is disposed in the second space S2.

In the electromagnetic relay 1B, when the coil 88 is energized, the armature 91 is attracted to the iron core 90 by the magnetic force of the coil 88. As a result, the armature 91 pivots against the biasing force of the return spring 93 to press the movable contact piece 85 via the card 94. Thereby, the movable contact piece 85 is elastically deformed, and the movable contact 87 moves in the contact direction (Z1). Thereby, the movable contact 87 contacts the fixed contact 86.

When the coil 88 is de-energized, the armature 91 pivots in the opposite direction due to the biasing force of the return spring 93. As a result, the pressing force of the card 94 on the movable contact piece 85 is released, and the elastic force of the movable contact piece 85 causes the movable contact 87 to move in the separation direction (Z2). Thereby, the movable contact 87 is separated from the fixed contact 86.

The electromagnetic relay 1B has adhesive materials 47 to 50. The adhesive materials 47 and 48 are disposed on the second case 96. The adhesive material 47 is disposed facing the movable contact piece 85. The adhesive material 47 is disposed between the movable contact 87 and a position where the movable contact piece 85 contacts the second case 96. The adhesive material 47 is disposed below the movable contact 87. The adhesive material 48 is disposed facing the fixed terminal 84. The adhesive material 48 is disposed below the fixed contact 86.

The adhesive materials 49 and 50 are attached to the first case 95. The adhesive material 49 is attached to an inner side surface of the first case 95. The adhesive material 49 is disposed between a gap G5 between the first case 95 and the second case 96 and the movable contact 87 and the fixed contact 86. The adhesive material 50 is attached to the partition wall 97. The adhesive material 50 is disposed between the armature 91 and the movable contact 87 and the fixed contact 86. The adhesive material 50 is disposed to face the armature 91.

Also in the electromagnetic relay 1B according to the second embodiment, similarly to the electromagnetic relay 1A according to the first embodiment, when foreign matter is generated in the case 81 or enters the case 81, the foreign matter is captured by the adhesive materials 47 to 50. As a result, adhesion of foreign matter to the fixed contact 86 or the movable contact 87 is reduced.

Only part of the adhesive materials 41 to 46 described above may be provided in the electromagnetic relay 1A according to the first embodiment. Only part of the adhesive materials 47 to 50 described above may be provided in the electromagnetic relay 1B according to the second embodiment. The arrangement of the adhesive materials 41 to 50 is not limited to that of the above embodiment, and may be changed.

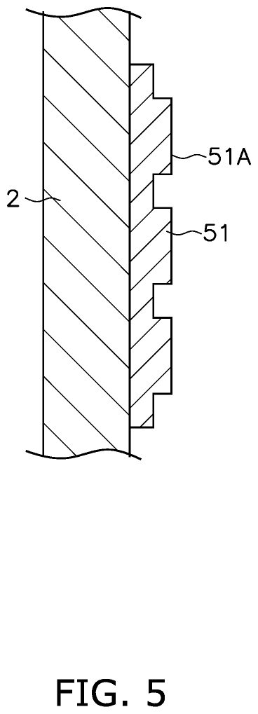

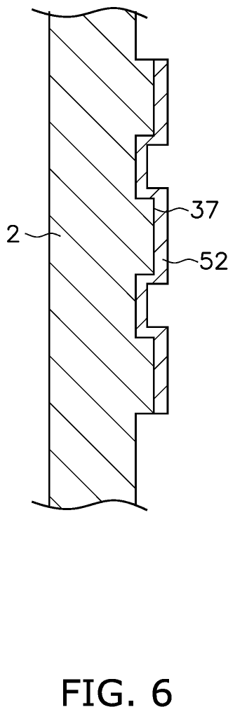

FIG. 5 is a diagram showing an adhesive material 51 according to a first modified example. As shown in FIG. 5, the adhesive material 51 may have an uneven surface 51A. FIG. 6 is a diagram showing an adhesive material 52 according to a second modified example. As shown in FIG. 6, the inner surface of the case 2 may include unevenness 37. The adhesive material 52 may be attached onto the unevenness 37. In this case, the adhesive material 52 may be, for example, a flexible tape. Alternatively, the adhesive material 52 may be liquid or gel and applied onto the unevenness 37.

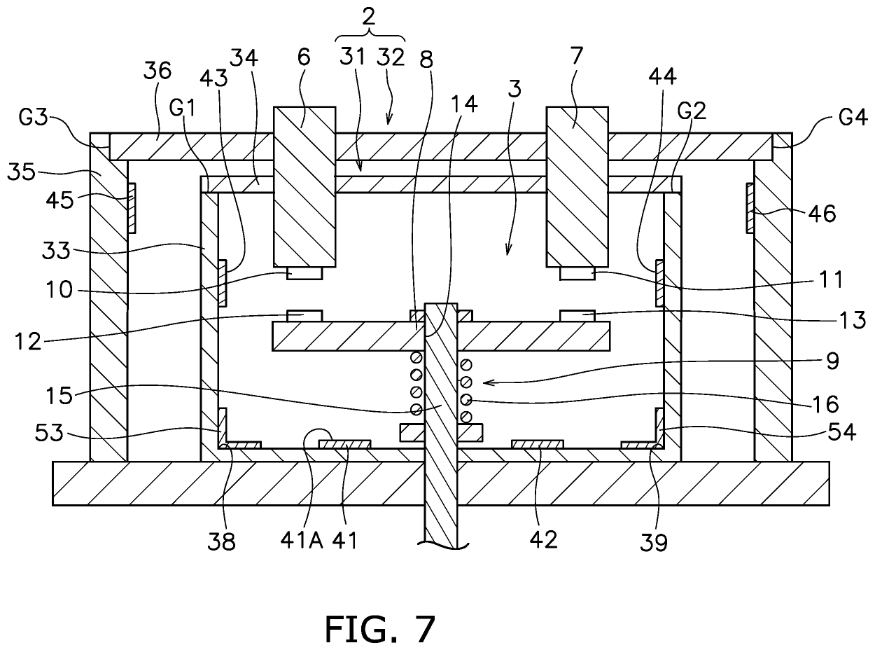

FIG. 7 is a diagram showing a contact device 3 and a case 2 according to a third modified example. As shown in FIG. 7, the inner surface of case 2 may include corners 38 and 39. Adhesive materials 53 and 54 may be attached to the corners 38 and 39.

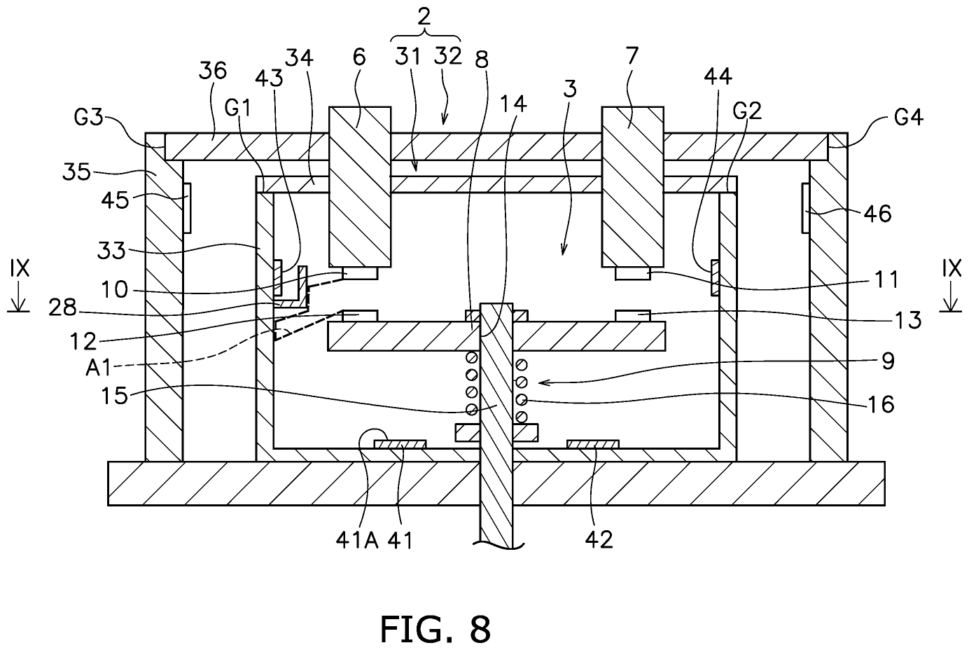

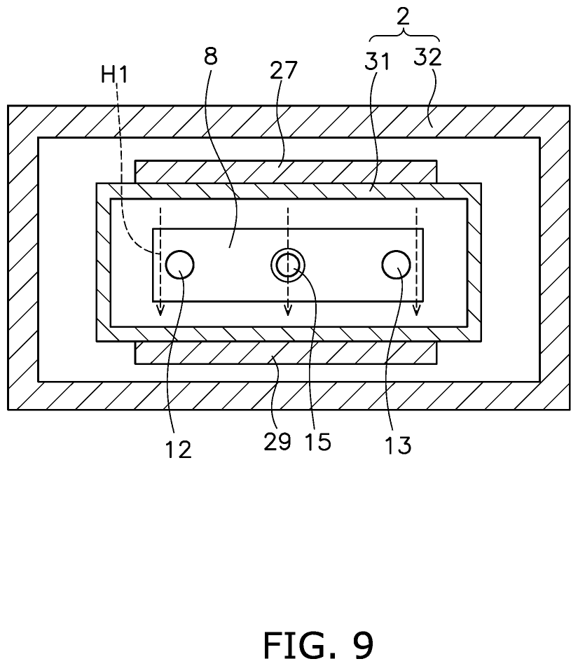

FIG. 8 is a diagram showing a contact device 3 and a case 2 according to a fourth modified example. FIG. 9 is a cross-sectional view taken along line IX-IX in FIG. 8. As shown in FIG. 9, the contact device 3 may include magnets 27 and 29. As shown in FIG. 8, the magnets 27 and 29 generate magnetic field H1 for inducing arc A1 generated between the movable contacts 12 and 13 and the fixed contacts 10 and 11. The arc A1 is extended toward the inner side surface of the case 2 by the Lorentz force due to the magnetic field H1. The case 2 may include a wall portion 28. The wall portion 28 may be disposed in the inner case 31 so as to face the adhesive material 43. The wall portion 28 may be disposed between the distracted arc A1 and the adhesive material 43. In this case, the adhesive material 43 is protected from the arc A1 by the wall portion 28. This suppresses deterioration of the adhesive material 43 due to the arc A1. It should be noted that wall portions may be provided for other adhesive materials as well.

### REFERENCE SIGNS LIST

2: Case, 8: Movable contact piece, 10: First fixed contact, 12: First movable contact, 27: Magnet, 28: Wall portion, 33: First inner case, 34: Second inner case, 35: First outer case, 36: Second outer case, 37: unevenness, 38: Corner, 41: Adhesive material

1. An electromagnetic relay, comprising:
a fixed contact;
a movable contact disposed to face the fixed contact;
a movable contact piece connected to the movable contact, the movable contact piece being movable between a closed position in which the movable contact contacts the fixed contact and an open position in which the movable contact separates from the fixed contact;
a case in which the fixed contact and the movable contact are disposed; and
an adhesive material disposed in the case, the adhesive material being tacky or sticky to capture foreign matter in the case.

2. The electromagnetic relay according to claim 1, further comprising
a movable member disposed in the case, wherein
the adhesive material is disposed between the movable member and the fixed contact or the movable contact.

3. The electromagnetic relay according to claim 1, wherein
the case includes
a first case, and
a second case provided separately from the first case, the second case being attached to the first case, and
the adhesive material is disposed between the fixed contact or the movable contact and a gap between the first case and the second case.

4. The electromagnetic relay according to claim 1, wherein
the adhesive material has an uneven surface.

5. The electromagnetic relay according to claim 1, wherein
an inner surface of the case includes unevenness, and
the adhesive material is attached on the unevenness.

6. The electromagnetic relay according to claim 1, wherein
an inner surface of the case includes a corner, and
the adhesive material is attached to the corner.

7. The electromagnetic relay according to claim 1, further comprising
a magnet that generates a magnetic force for inducing an arc generated between the movable contact and the fixed contact; and
a wall portion that faces the adhesive material in the case, the wall portion being configured to protect the adhesive material from the arc.
